(19) United States
(12) Patent Application Publication
(10) Pub. No.: US 2014/0338604 A1
(43) Pub. Date: Nov. 20, 2014

(54) DAIRY FARM SYSTEM AND METHOD THEREIN

(71) Applicant: DELAVAL HOLDING AB, Tumba (SE)

(72) Inventor: Bjarne Nebelong, Stockholm (SE)

(73) Assignee: DELAVAL HOLDING AB, Tumba (SE)

(21) Appl. No.: 14/367,947

(22) PCT Filed: Dec. 21, 2012
(86) PCT No.: PCT/SE2012/051472

§ 371 Date: Jun. 23, 2014

Related U.S. Application Data
(60) Provisional application No. 61/581,666, filed on Dec. 30, 2011.

(30) Foreign Application Priority Data
Dec. 30, 2011 (SE) 1151292-8

(51) Int. Cl. A01J 5/017; A01J 5/007

(52) U.S. Cl. CPC A01J 5/017; A01J 5/007
USPC 119/14.02; 119/14.03

(57) ABSTRACT

A dairy farm system, with specified zones each capable of housing one or more milking animals at a time, devices for performing actions related to milking animals in the zones, and a management system that controls the operation of the system and stores animal specific data including information of any zone where a milking animal is located at each instant. Each of the devices, each with control means and storage means provided thereon, is communicatively connected to the management system, and is associated with at least one zone in which the device operates. The management system sends the devices animal specific data of only the milking animals which enter, are about to enter, or have entered a zone with which a device is associated. The animal specific data contain control data used by the control means of the device for controlling the operation of the device.

### TECHNICAL FIELD OF THE INVENTION

The present invention relates generally to dairy farming, and more specifically to dairy farm systems and methods therein for managing large number of milking animals.

### DESCRIPTION OF RELATED ART AND BACKGROUND OF THE INVENTION

A dairy farm for housing large stocks of milking animals, e.g. hundreds or even thousands of milking animals, may comprise resting areas wherein milking animals are allowed to rest, feeding areas wherein milking animals are fed, and milking areas wherein milking animals are milked. The feeding areas may comprise a large number of grazing areas or pastures. Typically, very large stocks of milking animals are managed manually or semi-automatically. When managing such large stocks of milking animals a few problems may arise.

One problem encountered in automatic animal arrangements housing large stocks of milking animals is that it is more difficult to monitor and control, various devices for performing actions related to the milking animals as well as the milking animals themselves. The storing and/or processing capacity of the devices may limit the number of milking animals that can be handled and the time for finding a specified milking animal in the storage means and for retrieving data for the specified milking animal may be unacceptably long. Further, it may be more difficult to find a specified milking animal, which for example has to be treated manually by the farmer.

Another problem encountered is difficulties in obtaining high milking machine utilization. This problem is particularly noticeable at very large dairy farms partitioned in different sections, and which have a large number of milking robots for the milking.

### SUMMARY OF THE INVENTION

It is an object of the present invention to provide a dairy farm system and a method in a dairy farm system, which address the above issues.

It is a particular object of the invention to provide such system and method, which provide a fast and accurate control of the devices of the dairy farm system as well as of the milking animals therein.

It is a further object of the invention to provide such system and method, which are scalable to be able to manage very large stocks of milking animals and which are flexible and can be dynamically changed in order to cope with changes with respect to the devices of the dairy farm system and/or with respect to the milking animals therein.

It is yet a further object of the invention to provide such system and method, which are simple, robust, reliable, and of low cost.

These objects among others are, according to the present invention, attained by systems and methods as claimed in the appended patent claims.

According to a first aspect of the invention there is provided a dairy farm system for managing milking animals comprising a management system having control means for controlling the overall operation of the dairy farm system and devices such as e.g. milking devices, feeding devices, treating devices, and gate devices, for performing actions related to the milking animals, wherein each of the devices has control means for controlling the operation of the device and storage means, and is communicatively connected to the management system. The control means of the management system comprises storage means for storing, for each of the milking animals, animal specific data e.g. containing control data used by the control means of the device in controlling the operation of the device

The dairy farm system is divided into specified zones, each of which being capable of housing one or more specified ones of the milking animals, and each of the devices is associated with at least one of the zones. The animal specific data stored in the storage means of the management system include information of the at least one zone in which each of the milking animals is located at each instant. The management system is arranged to send to each of the devices animal specific data of only the milking animals which enter, are about to enter, or have entered the at least one zone, with which the device is associated, in response to which the device is arranged to store the animal specific data received from the management system in its storage means. To this end, the dairy farm system comprises an animal identification system arranged to identify the milking animals which enter, are about to enter, or have entered the at least one zone, with which the device is associated, and communication means arranged to communicate the identification data from the animal identification system to the management system.

The animal specific data contain control data used by the control means of the device in controlling the operation of the device

In one embodiment, animal identification devices are located at appropriate locations for identifying milking animals which enter, are about to enter, or have entered each zone, and are operatively connected to the management system in order to transmit such identifications of animals to the management system.

Preferably, the management system is arranged to inform each of the devices if a milking animal present in the at least one zone, with which the device is associated, leaves, is about to leave, or has left that zone, whereupon the device is arranged to erase the animal specific data of that milking animal from its storage means. The animal identification devices have thus also to identify such milking animal that leaves, is about to leave, or has left a zone and to forward such identification to the management system.

In one embodiment, the dairy farm system comprises passages such as fences passageways, paths, or routes between the specified zones in order to allow the milking animals to move from one of the specified zones to another one of the specified zones, wherein each of the passages is equipped with an identification device provided for identifying each of the milking animals which move from one of the specified zones to another one of the specified zones and communication means for communicating to the management system the identity of the milking animal such that the management system is capable of updating the information of the zone in which the milking animal is located. Optionally, each of the passages is provided with a gate device, preferably a selection gate device.

The above embodiment may be implemented in an outland grazing arrangement wherein a milking system and different pastures constitute different zones, and wherein passageways are leading from the pastures to the milking system. Also the various passageways may constitute different zones and may comprise devices for feeding the animals and or for giving them water and or treating them, wherein the devices are configured as those devices disclosed above. The arrangement may be provided with identification devices and communication means of the above kind at both ends of the passages.

In another embodiment, the management system is provided for changing the specified zones, preferably according to a specified scheme or in response to a changed operation parameter of the dairy farm system. To this end the management system is arranged to (i) send to each of the devices, animal specific data of a milking animal if that milking animal was not present in the zone, with which the device is associated, before the change of the specified zones, but is after the change of the specified zones present in the zone, with which the device is associated, whereupon the device is provided to store the animal specific data of that milking animal in its storage means; and (ii) inform each of the devices if a milking animal that was present in the zone, with which the device is associated, before the change of the specified zones, but is after the change of the specified zones not present in the zone, with which the device is associated, whereupon the device is provided to erase the animal specific data of that milking animal from its storage means.

In yet another embodiment, the management system is, for at least one of the devices, provided for changing the at least one zone, with which the device is associated, preferably according to a specified scheme or in response to a changed operation parameter of the dairy farm system. To this end the management system is arranged to (i) send to the device animal specific data of a milking animal if the milking animal is not present in the zone, with which the device was associated before the change of the zone, but is present in the zone, with which the device is associated after the change of the zone, whereupon the device is provided to store the animal specific data of that milking animal in its storage means; and (ii) inform the device if a milking animal that is present in the zone, with which the device was associated before the change of the zone, but is not present in the zone, with which the device is associated after the change of the zone, whereupon the device is provided to erase the animal specific data of that milking animal from its storage means.

According to a second aspect of the invention, a method is provided in a dairy farm system comprising a plurality of devices for performing actions related to milking animals, and a management system having control means which controls the operation of the dairy farm system and storage means which stores, for each of the milking animals, animal specific data, wherein each of the devices has control means for controlling the operation of the device and storage means. According to the method, zones of the dairy farm are specified, each of which being capable of housing one or several ones of the milking animals at a time. Each of the devices is associated with at least one of the zones. Information of the at least one zone in which each of the milking animals is located at each instant is stored in the animal specific data. For each of the devices, animal specific data of only the milking animals which enter, are about to enter, or have entered the at least one zone, with which the device is associated, are sent from the management system to the device, after which this animal specific data are stored in the storage means of the device. The animal specific data contain control data used by the control means of the device in controlling the operation of the device.

Preferably, each of the devices is informed by the management system if a milking animal present in the at least one zone, with which the device is associated, leaves, is about to leave, or has left that zone, in response to which the animal specific data of that milking animal is erased from the storage means of the device. The management system will know when animals enter, are about to enter, or have entered a zone, as well as when animals leave, are about to leave, or have left that zone by means of receiving such information from an animal identification system, e.g. including a number of appropriately located animal identification devices.

According to a third aspect of the invention there is provided a dairy farm system for managing milking animals comprising a management system having control means arranged to control the overall operation of the dairy farm system and storage means arranged to store, for each of the milking animals, animal specific data, and devices for performing actions related to the milking animals, wherein each of the devices has control means for controlling the operation of the device and storage means, and is communicatively connected to the management system. The dairy farm system is divided into different specified zones, each of which being capable of housing one or several ones of the milking animals at a time, each of the devices is associated with at least one of the zones, and each of at least some of the milking animals is only allowed to visit a subset of the specified zones.

Different milking animals are mixed with one another in at least one of the plurality of zones and are separated from one another in at least two of the plurality of zones; and an identification and passage system is arranged to identify each of the milking animals which visits a passage (33) leading away from a zone and to allow the identified milking animal to pass through the passage only if the milking animal is allowed to visit the zone to which the passage leads.

Each of the devices holds animal specific data only of the milking animals which are allowed to visit the at least one zone, with which the device is associated, wherein the animal specific data contain control data used by the control means of the device in controlling the operation of the device.

According to a fourth aspect of the invention, a method is provided in a dairy farm system comprising a plurality of devices for performing actions related to milking animals, and a management system having control means which controls the operation of the dairy farm system and storage means which stores, for each of the milking animals, animal specific data, wherein each of the devices has control means for controlling the operation of the device and storage means. According to the method, zones of the dairy farm system are defined, each of which being capable of housing one or several ones of the milking animals at a time.

Each of at least some of the animals is allowed to visit a subset only of the plurality of zones. Different milking animals are allowed to be mixed with one another in at least one of the plurality of zones and to be separated from one another in at least two of the plurality of zones; and each of the milking animals, which visits a passage leading away from a zone, is identified and the identified milking animal is allowed to pass through the passage only if the milking animal is allowed to visit the zone to which the passage leads.

Each of the devices is associated with at least one of the zones. For each of the devices, animal specific data of only the milking animals which are allowed to visit the at least one zone, with which the device is associated, are stored in the storage means of the device, wherein the animal specific data contain control data used by the control means of the device in controlling the operation of the device.

In the third and fourth aspects, the subset of the specified zones, which one of the animals is allowed to visit, may be reconfigured in response e.g. to an operator command and the animal specific data stored in the storage means of the device(s) associated with the changed subset of the specified zones may be updated with respect to the one of the animals.

This may, however, typically be made less than once a day, less than weekly, or less than monthly.

By the present invention it is rendered easier to monitor and control devices for performing actions related to the milking animals as well as the milking animals themselves. The storing and/or processing requirements of the devices can be relaxed and the time for finding a specified milking animal in the storage means and for retrieving data of the specified milking animal can be made fast and efficient.

The present invention is particularly well suited for managing very large number of milking animals such as e.g. at least several thousands of milking animals, but it is applicable also for managing smaller numbers of milking animals.

Further characteristics of the invention, and advantages thereof, will be evident from the following detailed description of preferred embodiments of the present invention given hereinafter and the accompanying FIGS. 1 and 2, which are given by way of illustration only, and thus are not limitative of the present invention.

### BRIEF DESCRIPTION OF THE DRAWINGS

FIGS. 1 and 2 illustrate schematically, in top views, dairy farm systems for managing a large number of milking animals according to different embodiments of the present invention.

### DETAILED DESCRIPTION OF EMBODIMENTS

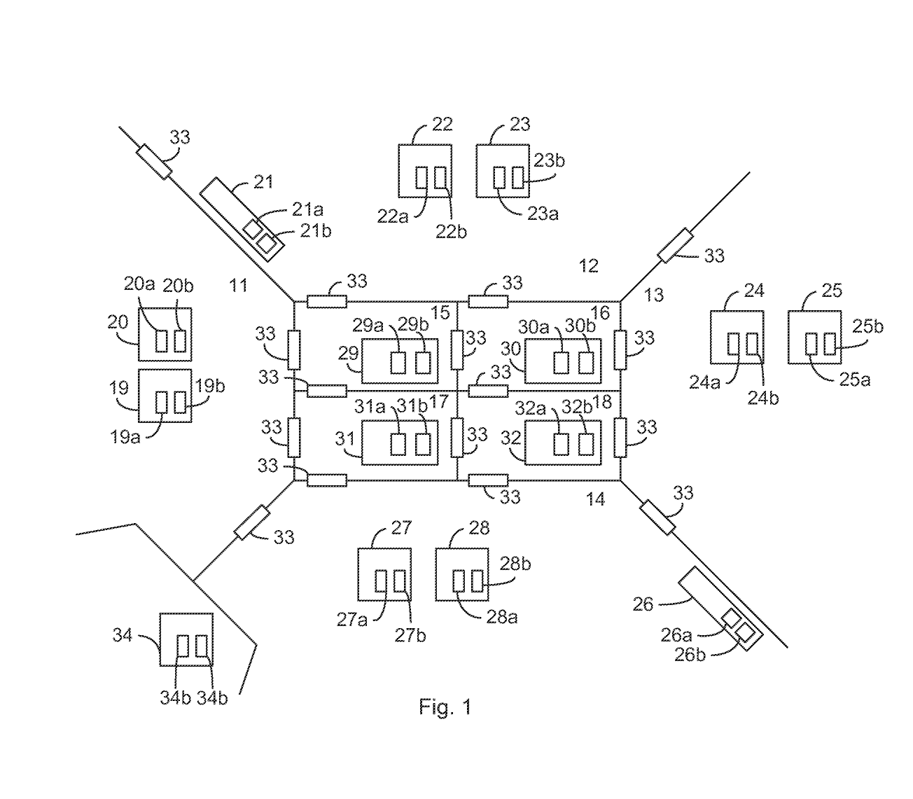

In FIG. 1 is illustrated a dairy farm system for managing a plurality of milking animals according to one embodiment of the invention. The dairy farm system comprises here eight enclosed areas 11-18: two resting and/or treating areas 11, 13, two feeding areas 12, 14, and four milking areas 15-18. Each of the areas 11-18 houses one or several devices 19-32 for performing actions related to the milking animals, wherein each of the devices 19-32 is provided with control means 19a-32a for controlling the operation of the device 19-32 and storage means 19b-32b. The control means 19a-32a may be a microcomputer or dedicated hardware and the storage means 19b-32b may be a memory.

The devices in FIG. 1 are distributed as follows. The area 11 houses two treating stations 19, 20, the area 12 houses one feeding table 21 and two feeding stations 22, 23, the area 13 houses two treating stations 24, 25, the area 14 houses one feeding table 26 and two feeding stations 27, 28, and the areas 15-18 house each a milking station 29-32, e.g. a voluntary or automated milking system, AMS, or a rotary milking system e.g. provided with robots for attaching teat cups to the teats of the milking animals to be milked.

A management system 34 is provided with control means 34a for controlling the overall operation of the dairy farm system and storage means 34b arranged to store, for each of the milking animals, animal specific data. The control means 34a may be a microcomputer and the storage means 34b may be a hard drive or similar, wherein the animal specific data are stored in a database therein.

The management system 34 is communicatively connected to each of the devices 19-32.

Further, a number of passages are provided which may allow milking animals to move from area to area. In the exemplary embodiment of FIG. 1, a passage having a gate device 33 is provided between each two adjacent ones of the areas 11-18. The gate devices 33 are each equipped with an identification device arranged to identify each of the milking animals which presents itself at the gate device 33, after which the gate device 33 opens and allows the milking animal to pass, optionally after having checked that the milking animal is allowed to pass that gate device 33. Depending on the application, some of the passages/gate devices 33 may be dispensed with.

The gate device 33 may be arranged for one-way passages or two-way passages. In other dairy farm system designs, the gate devices 33 may be provided with one inlet and two outlets leading to different areas or zones or may be provided with two inlets from different areas or zones and one outlet.

The dairy farm system is divided into specified zones, each of which being capable of housing one or more specified ones of the milking animals. For example each of the areas 11-18 may be a different zone. Optionally, the treating stations 19, 20, 24, 25, the feeding stations 22, 23, 27, 28, and the milking stations 29-32 are each a different zones.

Yet, optionally, two areas such as the milking areas 15, 16 may constitute one zone and the other two milking stations 17, 18 may constitute another zone.

Generally, a zone as defined herein is one or several physical areas. The zones may lye one within another, zones may overlap, and adjacent zones may be separated. As a consequence, a milking animal may be present in more than one zone at a time.

Further the division of the dairy farm system may be changed preferably according to a specified scheme or in response to a changed operation parameter of the dairy farm system. This will be exemplified later in this description.

Each of the devices 19-32 is associated with at least one of the zones, that is, the zone(s) in which the device 19-32 operates. If the eight areas 11-18 constitute the specified zones, the devices 19-32 are each associated with the zone which corresponds to the area 11-18 in which the device 19-32 is located.

The animal specific data stored in the storage means 34b of the management system 34 include information of the at least one zone in which each of the milking animals is located at each instant. To receive updated information regarding the location of the milking animals, the gate devices 33 are arranged to transmit information regarding the identifications of the milking animals that pass the gate devices 33. To this end the gate devices 33 are provided with wired or wireless communication capabilities with the management system 34.

Similarly, if the devices 19-32 each comprises a zone, each of the stations has to be provided with an animal identification device for identifying milking animals entering, being about to enter, or having entered that station, which is operatively connected to the management system 34 in order to supply the management system with the identifications.

Alternatively, or additionally, the dairy farm system comprises other kind of animal identification system arranged to identify each of the milking animals which move from one of the specified zones to another one of the specified zones and communication means arranged to communicate the identification data to the management system.

Such animal identification system may comprise a camera system including a plurality of cameras, a GPS system, or a radio based positioning system.

Typically, however, each zone comprises more than one of the devices 19-32.

The management system 34 is in turn arranged to send to each of the devices 19-32 animal specific data of only the milking animals which enter, are about to enter, or have entered the at least one zone, with which the device 19-32 is associated, whereupon the device 19-32 is arranged to store the animal specific data received from the management system 34 in its storage means 19b-32b.

The animal specific data contain typically control data used by the control means 19a-32a of each of the devices 19-32 in controlling the operation of the device 19-32 with respect to a given milking animal. If the device is a milking system, the animal specific data of a milking animal may comprise data regarding how the milking animal should be treated and/OR milked, how the milking animal should be fed and/or enticed to a appropriate position, how the milk should be treated and/or collected, etc. If the device is a feeding station, the animal specific data of a milking animal may comprise data regarding how the milking animal should be fed, how often the milking animal should be fed, what kind of feed the milking animal should be fed with, etc. If the device is a treating station, the animal specific data of a milking animal may comprise data regarding how the milking animal should treated, when the milking animal should be treated, etc. If the device is a selection gate device, the animal specific data of a milking animal may comprise data regarding how the milking animal should traffic the dairy farm system, etc.

Also, each of the gate devices 33 may be associated with at least one of the zones, preferably, the zone(s) to which the gate device 33 leads and optionally the zone(s) from which the gate device 33 is accessed. The management system sends to each of the gate devices 33 animal specific data of only the milking animals which enter, are about to enter, or have entered the at least one zone, with which the gate device 33 is associated, in response to which the gate device 33 stores the animal specific data received from the management system 34.

Preferably, the management system 34 is arranged to inform each of the devices 19-32 if a milking animal present in the zone, with which the device 19-32 is associated, leaves, is about to leave, or has left, that zone, whereupon the device 19-32 is arranged to erase the animal specific data of that milking animal from its storage means.

The management system 34 may be arranged to inform each of the devices 19-32 about milking animals entering and leaving the zone, with which the device 19-32 is associated, immediately for each entering and/or each leaving repeatedly, preferably regularly.

By such provisions the devices for performing actions related to the milking animals as well as the milking animals themselves are easier to monitor and control. The storing and/or processing requirements of the devices 19-32 are relaxed and the time for finding a specified milking animal in the storage means 19b-32b and for retrieving data of the specified milking animal can be made fast and efficient. In particular, devices having physical limitations with respect to storage and/or processing capacity can be used since less data have to be handled by the devices. Response times from the management system 34 may be too long to rely on downloading data as they are needed. Further, some of the devices such as e.g. a feed device may not be operatively connected to the management system 34 at all times as being described in WO2007/071406, the contents of which being hereby incorporated by reference.

Further, if a manual input device as disclosed in EP 1936474, i.e. a manual input device, wherein on entry of an initial piece of data, the device will suggest one or more possible animal identification numbers, is used in a zone of the present invention, it will faster suggest the correct animal identification number since the device will only contain animal specific data for a small subset of the milking animals managed by the entire dairy farm system. The contents of EP 1936474 are hereby incorporated by reference. It shall be appreciated that any kind of search of the above mentioned kind can be made faster since the animal specific data which have to be searched are heavily reduced.

In a further embodiment of the invention the management system is arranged to change the specified zones, preferably according to a specified scheme or in response to a changed operation parameter of the dairy farm system. In response to such change the management system 34 is arranged to send to each of the devices 19-32 animal specific data of a milking animal if that milking animal was not present in the zone, with which the device 19-32 is associated, before the change of the specified zones, but is after the change of the specified zones present in the zone, with which the device 19-32 is associated, whereupon the device 19-32 is arranged to store the animal specific data of that milking animal in its storage means 19b-32b. Correspondingly, each of the devices 19-32 is informed by the management system 34 if a milking animal that was present in the zone, with which the device 19-32 is associated, before the change of the specified zones, but is after the change of the specified zones not present in the zone, with which the device is associated, whereupon the device 19-32 is arranged to erase the animal specific data of that milking animal from its storage means 19b-32b.

This embodiment will be exemplified with respect to FIG. 1. Assume the following scenario. The milking animals are divided up into two groups depending on some kind of criterion, e.g. milk production capacity. A first group of the milking animals have access to areas 11, 12, 15, 16, which constitute a first zone, whereas a second group of the milking animals have access to areas 13, 14, 17, 18, which constitutes a second zone. All devices in areas 11, 12, 15, 16 are associated with the first zone and all devices in areas 13, 14, 17, 18 are associated with the second zone. The group wise separation of the milking animals is terminated and all milking animals are allowed to visit all areas. New zones are specified: a first zone is specified as covering areas 11, 12, a second zone is specified as covering areas 13, 14, and a third zone is specified as covering areas 15-18. All milking animals located in areas 15, 16 are after the change of the zones present in the third zone instead of in the first zone and all milking animals located in areas 17, 18 are after the change of the zones present in the third zone instead of in the second zone.

The management system 34 is arranged to send to each of the devices 29, 30 located in areas 15, 16 animal specific data of the milking animals present in areas 17, 18 and to inform each of the devices 29, 30 located in areas 15, 16 of the milking animals present in areas 11, 12 which are no longer in the same zone as areas 15, 16. Each of the devices 29, 30 stores the received animal specific data and erases the animal specific data of the animals present in areas 11, 12. Present means here and below present at the time of the change of the specified zones.

Similarly, the management system 34 is arranged to send to each of the devices 31, 32 located in areas 17, 18 animal specific data of the milking animals present in areas 15, 16 and to inform each of the devices 31, 32 located in areas 17, 18 of the milking animals present in areas 13, 14 which are no longer in the same zone as areas 17, 18. Each of the devices 31, 32 stores the received animal specific data and erases the animal specific data of the animals present in areas 13, 14.

Finally, the management system 34 is arranged to inform each of the devices 19-23 located in areas 11, 12 of the milking animals present in areas 15, 16 which are no longer in the same zone as areas 11, 12, and to inform each of the devices 24-28 located in areas 13, 14 of the milking animals present in areas 17, 18 which are no longer in the same zone as areas 13, 14. Each of the devices 19-23 is arranged to erase the animal specific data of the animals present in areas 15, 16, and each of the devices 24-28 is arranged to erase the animal specific data of the animals present in areas 17, 18.

In a yet further embodiment of the invention the storage means 19b-32b of each of the devices 19-32 is not dynamically storing animal specific data of only the milking animals located in the zone, with which the devices 19-32 is associated, at each instant, but is storing animal specific data of the milking animals that are allowed to be in a zone, with which the devices 19-32 is associated. This embodiment requires that each of at least some of the milking animals is only allowed to visit a subset of the zones. Typically, each of the milking animals is only allowed to visit a few, e.g. 2-10 zones, out of a large number of zones, e.g. more than 25, 100, 500, or even 1000. In this embodiment the management system 34 does not necessarily has to know, at each instant, in which zone each milking animal is.

This embodiment may also be modified to cope with changes of the specified zones or changes of the zones that the at least some of the milking animals are allowed to visit. Special care has to be taken to avoid that a milking animal ends up being in a non-allowed zone after the change.

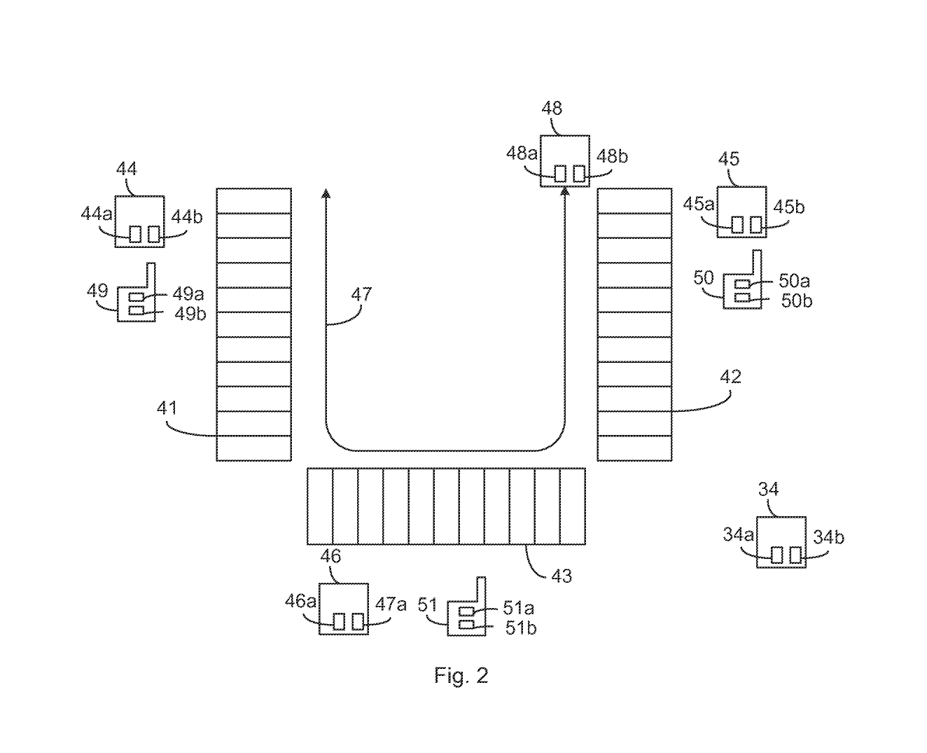

In FIG. 2 is illustrated a dairy farm system for managing a plurality of milking animals according to a still further embodiment of the invention. The dairy farm system comprises three milking systems 41-43 of the parallel stall type, each being provided with one or advantageously a plurality of animal identification devices. Each of the milking systems 41-43 may comprise a large number of milking stalls, each housing a respective milking animal. The three milking systems constitute three different specified zones.

Further, the dairy farm system comprises various movable or portable devices 44-46, 48-51. For each of the milking systems 41-43 there is provided a milking device 44, 45, 46, and a PDA or operator communication device 49, 50, 51. Further, there is provided a feeding device 48 movable along a rail 47 or similar in a path passing each of the milking systems 41-43. Each of the devices 44-46, 48-51 includes control means 44a-46a, 48a-51a and storage means 44b-46b, 48b-51b. It shall be appreciated that there may be more than three milking systems and thus zones in the dairy farm system and more than one milking device for each of the milking systems.

Each of the devices 44-46, 48-51 is operatively connected to the management system 34, which keeps track on the zone(s) in which milking animal is or is allowed to be. In the former case appropriately located animal identification devices are used to locate the milking animals.

Each of the devices 44-46, 48-51 is associated with at least one of the specified zones, that is, devices 44 and 49 are associated with the zone corresponding to milking system 41, devices 45 and 50 are associated with the zone corresponding to milking system 42, devices 26 and 51 are associated with the zone corresponding to milking system 43, and the feeding device 48 is associated with a different one of the zones during different times, preferably according to a specified scheme or in response to a changed operation parameter of the dairy farm system.

Each of the devices 44-46, 48-51 is, at each time, arranged to store animal specific data of only the milking animals located, or allowed to be, in the zone with which the device 44-46, 48-51 is associated at that time.

This means that if the feeding device 48 is scheduled to feed milking animals in the zone corresponding to milking system 41 during a first hour, to feed milking animals in the zone corresponding to milking system 42 during a second hour, and to feed milking animals in the zone corresponding to milking system 43 during a third hour, the feeding device 48 is arranged to store in its storage means 48b animal specific data only for the milking animals present in the zone corresponding to milking system 41 at the start of the first hour and for those who enter the zone corresponding to milking system 41 during the first hour, or only for the milking animals which are allowed to be in the zone corresponding to milking system 41. Then, the feeding device 48 is arranged to store in its storage means 48b animal specific data only for the milking animals present in the zone corresponding to milking system 42 at the start of the second hour and for those who enter the zone corresponding to milking system 42 during the second hour, or only for the milking animals which are allowed to be in the zone corresponding to milking system 42. Finally, the feeding device 48 is arranged to store in its storage means 48b animal specific data only for the milking animals present in the zone corresponding to milking system 43 at the start of the third hour and for those who enter the zone corresponding to milking system 43 during the third hour, or only for the milking animals which are allowed to be in the zone corresponding to milking system 43. After three hours, and optionally after a short resting period, the feeding device 48 is arranged to repeat the three-hour feeding scheme. The animal specific data here may comprise an animal specific recipe or ration.

While the present invention has been described in a plurality of embodiments it shall be appreciated that it may be practiced in yet further embodiments falling within the scope of the appended patent claims. In particular, it shall be appreciated that the present invention is most useful in larger dairy farm systems with many more areas, milking animals, milking systems, devices, and/or zones, than described above.

It shall further be appreciated that the inventive concept disclosed above may be implemented in any kind of dairy farm system, e.g. such as those based on parlor milking systems or rotary milking systems. Still further, the dairy farm system may be a stanchion barn.

1-14. (canceled)

15. A dairy farm system, comprising:
a plurality of specified zones, each one of said specified zones being capable of housing one or several ones of a plurality of milking animals at a time;
a plurality of devices (19-32; 44-46, 48-51) that perform actions related to the plurality of milking animals in the plurality of specified zones,
each device being associated with at least one of the specified zones, and each device comprising
device control means (19a-32a; 44a-46a, 48a-51a) for controlling the operation of the device, and
device data storage means (19b-32b; 44a-46b, 48a-51b) in connection with the device control means; and
a management system (34) communicatively connected to the plurality of devices, the management system having control means (34a) provided for controlling the operation of the dairy farm system and data storage means (34b) having stored thereon, for each of the milking animals, animal specific data including information identifying a specified zone in which each milking animal is located at each instant; and
an animal identification system, operatively connected to the management system, that identifies, and communicates identification data to the management system when any milking animal is about to enter or has entered any of the specified zones,
wherein the management system, in response to receiving identification data from the animal identification system of a milking animal that is about to enter or has entered a specified zone associated with one or more devices, send to each of the one or more devices associated with the specified zone an update that includes animal specific data of the milking animal that is about to enter or has entered the specified zone associated with the one or more devices and is free of animal specific data concerning any other milking animal of the plurality of milking animals,
wherein each of the devices, in response to receiving the update from the management system, stores the animal specific data received from the management system in respective device data storage means thereof, and
wherein the animal specific data contain device control data, and the control means of each of the devices controls the operation of the device in accordance with said device control data.

16. The dairy farm system of claim 15, wherein the management system, in response to receiving identification data from the animal identification system of a milking animal that is leaving, is about to leave, or has left the specified zone with which the one or more devices is associated, sends a message to each the one or more devices which causes each of the one or more devices to erase, from the respective storage means thereof, the animal specific data of the milking animal that is leaving, is about to leave, or has left the specified zone.

17. The dairy farm system of claim 15, wherein the plurality of devices is any of a gate device, a milking device, a treatment device, and a feeding device.

18. The dairy farm system of claim 15, further comprising:
passages (33) providing a path for the milking animals between the specified zones, each of the passages equipped with a gate device,
said gate device including an identification device that determines an identity of any milking animal moving from one of the specified zones to another one of the specified zones, and communication means for communicating the identity to the management system such that the management system updates and maintains current the information of the specified zone in which each of the milking animals are located at each instant.

19. The dairy farm system of claim 15,
wherein the devices comprise any of a gate device, a milking device, a treatment device, and a feeding device,
wherein a specified zone of the plurality of specified zones comprises a gate device located at the entrance to the specified zones, and the at least one of a milking device, a treatment device, and a feeding device provided inside the specified zones,
the gate device including an identification device, in operative communication with the management device, that determines and transmits an identity of any milking animal that is any of about to enter, entering, has entered, about to exit, exiting, and has exited the specified zone to the management system,
wherein, upon receiving an identity of a milking animal that is any of about to enter, entering, has entered the specified zone, the management system transmits to each of the devices of the specified zone an update that includes the animal specific data of the milking animal that is any of about to enter, entering, has entered the specified zone, and
wherein, upon receiving an identity of a milking animal that is any of about to exit, exiting, has exited the specified zone, the management system informs each of the devices of the specified zone to erase the animal specific data of the milking animal that is any of about to exit, exiting, has exited the specified zone,
each of the devices of the specified zone, upon being informed by the management system, erasing the animal specific data, from respective device storage means thereof, of the milking animal that is any of about to leave, leaving, or has left the specified zone.

20. The dairy farm system of claim 15, wherein, in the event of a change of the specified zones such that a device is no longer associated with an first specified zone and is to be associated with a second specified zone,
send to the device animal specific data of a first milking animal if the first milking animal was not present in the first specified zone with which the device is associated before the change of the specified zones, but is, after the change of the specified zones, present in the second specified zone with which the device is to be associated, whereupon the device is provided to store the animal specific data of the first milking animal in the device storage means thereof, and
inform the device if a second milking animal that was present in the first specified zone with which the device is associated before the change of the specified zones, but is, after the change of the specified zones, not present in the second specified zone with which the device is associated, whereupon the device is provided to erase the animal specific data of the second milking animal from the storage means thereof.

21. The dairy farm system of claim 15, further comprising:
a passage system that provides paths for the milking animals between the specified zones, each passage of the passage system equipped with a gate device,
said gate device including an identification device that determines an identity of any milking animal moving from one of the specified zones to another one of the specified zones, and communication means for communicating the identity to the management system such that the management system updates and maintains current the information of the specified zone in which each of the milking animals are located at each instant,
the management system and passage system providing that each of at least some of the milking animals is only allowed to visit a subset of the plurality of specified zones, the passage system indentifying each of the milking animals which visits a passage (33) of the passage system leading away from a zone and permitting the identified milking animal to pass through the passage if the milking animal is allowed to visit the zone to which the passage leads and to deny the identified milking animal from passing through the passage if the milking animal is not allowed to visit the zone to which the passage leads.

22. The dairy farm system of claim 21, wherein different milking animals are mixed with one another in at least one of the plurality of zones and are separated from one another in at least two of the plurality of zones.

23. The dairy farm system of claim 21, wherein in the event that the subset of the plurality of specified zones is reconfigured with respect to one of the milking animals, the management system updates all devices associated with the changed subset of the plurality of specified zones with respect to said one of the milking animals.

24. The dairy farm system of claim 16, further comprising:
passages (33) providing a path for the milking animals between the specified zones, each of the passages equipped with a gate device,
said gate device including an identification device that determines an identity of any milking animal moving from one of the specified zones to another one of the specified zones, and communication means for communicating the identity to the management system such that the management system updates and maintains current the information of the specified zone in which each of the milking animals are located at each instant.
wherein at least one of the specified zones comprises an area of the dairy farm having at least a gate device and two or more milking devices, treatment devices, or feeding devices.

25. A method in a dairy farm system that includes i) a plurality of devices (19-32; 44-46, 48-51) for performing actions related to a plurality of milking animals and ii) a management system (34) having control means (34a) which controls the operation of the dairy farm system and storage means (34b) having stored thereon, for each of the milking animals, animal specific data, each one of the plurality of devices having device control means (19a-32a; 44a-46a, 48a-51a) for controlling the operation of the device and device storage means (19b-32b; 44a-46b, 48a-51b), the method comprising the steps of:
at the management system, defining a plurality of specified zones of the dairy farm system, each one of said plurality of specified zones being capable of housing one or several ones of the milking animals at a time;
at the management system, associating each of the devices with at least one of the specified zones;
at the management system, storing location information provided by an animal identification system in the animal specific data for each one of the milking animals comprising information of a specified zone of the plurality of specified zones in which the each of the milking animals is located at each instant,
the animal identification system identifying and communicating identification data to the management system for any milking animal that has entered or is about to enter any one of said plurality of specified zones;
at the management system, upon receiving identification data from the animal identification system of a milking animal that has entered or is about to enter a specified zone with which one or more of the devices is associated, transmitting an updated to each of the one or more of the devices, the update including animal specific data of the milking animal that has entered or is about to enter the specified zone with which the one or more of the devices is associated and is free of animal specific data concerning any other milking animal of the plurality of milking animals; and
at each of the one or more of the devices, storing in respective storage means thereof the animal specific data transmitted by the management system, wherein
the animal specific data contain control data that is used by respective control means of the one or more of the devices to control a respective operation of the one or more of the devices.

26. The method of claim 25, further comprising:
at the management system, upon receiving identification data from the animal identification system indicating that a milking animal, present in the specified zone with which the one or more of the devices is associated, is leaving, is about to leave, or has left the specified zone with which the one or more of the devices is associated, sending a message to each of the one or more of the devices which causes each of the one or more of the devices to erase, from the respective storage means thereof, the animal specific data of the milking animal that is leaving, is about to leave, or has left the specified zone.

27. The method of claim 25, wherein the plurality of devices is any of a gate device, a milking device, a treatment device, and a feeding device.

28. The method of claim 25, further comprising:
providing passages that provide a path for the milking animals between the specified zones, each of the passages equipped with a gate device,
said gate device including an identification device that determines an identity of any milking animal moving from one of the specified zones to another one of the specified zones, and communication means for communicating the identity to the management system such that the management system updates and maintains current the information of the specified zone in which each of the milking animals are located at each instant.

29. The method of claim 25,
wherein the devices comprise any of a gate device, a milking device, a treatment device, and a feeding device,
wherein a specified zone of the plurality of specified zones comprises a gate device located at the entrance to the specified zones, and the at least one of a milking device, a treatment device, and a feeding device provided inside the specified zones,
the gate device including an identification device, in operative communication with the management device, that determines and transmits an identity of any milking animal that is any of about to enter, entering, has entered, about to leave, leaving, and has left the specified zone to the management system,
wherein, upon receiving an identity of a milking animal that is any of about to enter, entering, has entered the specified zone, the management system transmits to each of the devices of the specified zone an update that includes the animal specific data of the milking animal that is any of about to enter, entering, has entered the specified zone, and
wherein, upon receiving an identity of a milking animal that is any of about to leave, leaving, or has left the specified zone, the management system informs each of the devices of the specified zone to erase the animal specific data of the milking animal that is any of about to leave, leaving, or has left the specified zone,
each of the devices of the specified zone, upon being informed by the management system, erasing the animal specific data, from respective device storage means thereof, of the milking animal that is any of about to leave, leaving, or has left the specified zone.

30. The method of claim 25, further comprising:
changing the specified zones such that a device is no longer associated with an first specified zone and is to be associated with a second specified zone, comprising:
sending to the device animal specific data of a first milking animal if the first milking animal was not present in the first specified zone with which the device is associated before the change of the specified zones, but is, after the change of the specified zones, present in the second specified zone with which the device is to be associated, whereupon the device is provided to store the animal specific data of the first milking animal in the device storage means thereof, and
informing the device if a second milking animal that was present in the first specified zone with which the device is associated before the change of the specified zones, but is, after the change of the specified zones, not present in the second specified zone with which the device is associated, whereupon the device is provided to erase the animal specific data of the second milking animal from the storage means thereof.

31. The method of claim 25, further comprising:
providing a passage system that provides paths for the milking animals between the specified zones, each passage of the passage system equipped with a gate device,
said gate device including an identification device that determines an identity of any milking animal moving from one of the specified zones to another one of the specified zones, and communication means for communicating the identity to the management system such that the management system updates and maintains current the information of the specified zone in which each of the milking animals are located at each instant,
the management system and passage system providing that each of at least some of the milking animals is only allowed to visit a subset of the plurality of specified zones, the passage system indentifying each of the milking animals which visits a passage (33) of the passage system leading away from a zone and permitting the identified milking animal to pass through the passage if the milking animal is allowed to visit the zone to which the passage leads and to deny the identified milking animal from passing through the passage if the milking animal is not allowed to visit the zone to which the passage leads.

32. The method according to claim 31, wherein different milking animals are mixed with one another in at least one of the plurality of zones and are separated from one another in at least two of the plurality of zones.

33. The method according to claim 31, wherein in the event that the subset of the plurality of specified zones is reconfigured with respect to one of the milking animals, the management system updates all devices associated with the changed subset of the plurality of specified zones with respect to said one of the milking animals.

34. The dairy farm system of claim 26, further comprising:
providing passages (33) for the milking animals between the specified zones, each of the passages equipped with a gate device,
said gate device including an identification device that determines an identity of any milking animal moving from one of the specified zones to another one of the specified zones, and communication means for communicating the identity to the management system such that the management system updates and maintains current the information of the specified zone in which each of the milking animals are located at each instant.
wherein at least one of the specified zones comprises an area of the dairy farm having at least a gate device and two or more milking devices, treatment devices, or feeding devices.
